(19) United States
(12) Patent Application Publication
(10) Pub. No.: US 2017/0077780 A1
(43) Pub. Date: Mar. 16, 2017

(54) STATOR CAN FOR IMPROVED ROTORDYNAMIC STABILITY

(71) Applicant: Dresser-Rand Company, Olean, NY (US)

(72) Inventors: Joseph A. Tecza, Scio, NY (US); William C. Maier, Almond, NY (US)

(73) Assignee: Dresser-Rand Company, Olean, NY (US)

(21) Appl. No.: 15/307,850

(22) PCT Filed: Mar. 20, 2015
(86) PCT No.: PCT/US2015/021629

§ 371 Date: Oct. 31, 2016

Related U.S. Application Data
(60) Provisional application No. 62/006,365, filed on Jun. 2, 2014.

(51) Int. Cl. H02K 5/24; H02K 5/128; H02K 7/09; H02K 1/20

(52) U.S. Cl. CPC H02K 5/24; H02K 1/20; H02K 5/1282; H02K 7/09; H02K 2005/1287

(57) ABSTRACT

A stator can for an electric motor of a motor-compressor is provided. The stator can may include an annular body configured to be disposed radially outward of a rotor of the electric motor. An inner radial surface of the annular body and an outer radial surface of the rotor may at least partially define a radial gap therebetween, and a first axial end portion of the annular body may at least partially define an inlet of the radial gap. The stator can may include a plurality of swirl breaks disposed about the first axial end portion of the annular body. The plurality of swirl breaks may be configured to reduce a swirling flow of the process fluid flowing to the inlet of the radial gap.

### CROSS REFERENCE TO RELATED APPLICATIONS

This application claims priority to U.S. Provisional Patent Application having Ser. No. 62/006,365, which was filed Jun. 2, 2014. The aforementioned patent application is hereby incorporated by reference in its entirety into the present application to the extent consistent with the present application.

### BACKGROUND

Rotating machines, such as turbines, compressors, and compact motor-compressors, are often utilized in a variety of industrial applications and processes to pressurize or compress a process fluid (e.g., high density process fluid). FIG. 1 illustrates a cross-sectional, schematic view of a conventional rotating machine 100, illustrated as a compact motor-compressor. In the compact motor-compressor 100, a high-speed electric motor 102 may be combined with a compressor 104, such as a centrifugal compressor, in a single, hermetically-sealed housing 106. As illustrated in FIG. 1, the housing 106 may include a compressor section 108 and a motor section 110 configured to hermetically seal the electric motor 102 and the compressor 104. For example, the electric motor 102 may be disposed in the motor section 110 of the housing 106, and the compressor 104 may be disposed in the compressor section 108 of the housing 106. Through a shared or coupled rotary shaft 112 supported by one or more bearings (four are shown 114), the electric motor 102 may drive or rotate the compressor 104 to compress or pressurize the process fluid.

As illustrated in FIG. 1, the electric motor 102 may include a stator 116 mounted to the housing 106 and a rotor 118 configured to drive the compressor 104 via the rotary shaft 112. As the electric motor 102 drives the compressor 104, heat may be generated through windage friction resulting from the rotating components of the compact motor-compressor 100. In the compact motor-compressor 100, the electric motor 102 may be immersed in the pressurized process fluid contained in the housing 106, which may act as a cooling fluid to dissipate the heat. For example, a portion of the process fluid may be directed to and through a gap 120 (i.e., a magnetic air gap) defined between the stator 116 and the rotor 118 to dissipate the heat. While the process fluid may be effective in dissipating the heat generated by the electric motor 102, the process fluid may also compromise the integrity of one or more components of the stator 116. For example, the process fluid may contain salt water, hydrogen sulfide, one or more hydrocarbons (e.g., methane), and/or other contaminants, that may compromise the integrity of a core 122 and/or windings 124 of the stator 116.

In view of the foregoing, the stator 116, including the core 122 and the windings 124 thereof, may often be encased or enclosed in a stator “can” 126 configured to provide a barrier between the stator 116 and the process fluids contained in the housing 106. The inclusion of the stator can 126, however, may increase the dimensions of the stator 116 and decrease the dimensions (e.g., radial length) of the magnetic air gap 120 defined between the stator 116 and the rotor 118. The decrease in the radial length of the magnetic air gap 120 in combination with the high-density process fluid flowing therethrough may generate or increase destabilizing forces acting on the rotor 118 and/or the rotary shaft 112 coupled therewith. For example, eccentric rotation of the rotor 118 within the stator 116 may cause the high-density process fluid to be flowed or whirled asymmetrically into the magnetic air gap 120, thereby generating or increasing the destabilizing forces (e.g., radial inward forces) acting on the rotor 118 and/or the rotary shaft 112 coupled therewith. In some cases, the bearings 114 may be capable of damping the destabilizing forces acting on the rotor 118. In other cases, however, the bearings 114 may not be capable of damping the destabilizing forces acting on the rotor 118. The improper management of the destabilizing forces may often lead to increased vibrations and rotordynamic instability of the rotor 118, which may ultimately result in failure of the electric motor 102 and the compact motor-compressor 100.

What is needed, then, is an improved stator can for managing the generation of destabilizing forces in an electric motor.

### SUMMARY

Embodiments of the disclosure may provide a stator can for an electric motor. The stator can may include an annular body configured to be disposed radially outward of a rotor of the electric motor. An inner radial surface of the annular body and an outer radial surface of the rotor may at least partially define a radial gap therebetween, and a first axial end portion of the annular body may at least partially define an inlet of the radial gap. The stator can may also include a plurality of swirl breaks disposed about the first axial end portion of the annular body and configured to reduce a swirling flow of a cooling fluid flowing to the inlet of the radial gap.

Embodiments of the disclosure may also provide another stator can for an electric motor. The stator can may include a hollow, annular body disposed radially outward of a rotor of the electric motor such that an inner radial surface of the annular body and an outer radial surface of the rotor at least partially define a radial gap therebetween. The hollow, annular body of the stator can may define a plurality of geometries along the inner radial surface thereof. The stator can may include a plurality of swirl breaks disposed about a first axial end portion of the annular body. The plurality of swirl breaks may be configured to reduce a swirling flow of a cooling fluid flowing to an inlet of the radial gap.

Embodiments of the disclosure may also provide an electric motor for a motor-compressor. The electric motor may include a rotor and a stator disposed radially outward of the rotor. The electric motor may also include a stator can enclosing the stator. The stator can may be configured to protect the stator from a process fluid flowing through the motor-compressor and increase rotordynamic stability of the rotor. The stator can may include an annular body disposed radially outward of the rotor. An inner radial surface of the annular body and an outer radial surface of the rotor may at least partially define a radial gap therebetween, and a first axial end portion of the annular body may at least partially define an inlet of the radial gap. The stator can may include a plurality of vanes disposed about the first axial end portion of the annular body. The plurality of vanes may be configured to reduce a swirling flow of the process fluid flowing to the inlet of the radial gap and thereby increase the rotordynamic stability of the rotor.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a cross-sectional schematic view of a conventional rotating machine, illustrated as a compact motor-compressor, according to the prior art.

FIG. 2A illustrates a cross-sectional, schematic view of a motor section of a motor-compressor including an exemplary electric motor that may be utilized in place of the electric motor of FIG. 1, according to one or more embodiments disclosed.

FIG. 2B illustrates a cross-sectional view of the electric motor taken along line 2B-2B in FIG. 2A, according to one or more embodiments disclosed.

FIG. 3 illustrates a perspective view of an arcuate segment of another stator can that may be utilized in place of the stator can of FIGS. 2A and 2B, according to one or more embodiments disclosed.

FIG. 4A illustrates a partial perspective view of an arcuate segment of another stator can that may be utilized in place of the stator can of FIGS. 2A and 2B, according to one or more embodiments disclosed.

FIG. 4B illustrates a cross-sectional view of the stator can taken along line 4B-4B in FIG. 4A, according to one or more embodiments disclosed.

FIG. 5A illustrates a partial perspective view of an arcuate segment of another stator can that may be utilized in place of the stator can of FIGS. 2A and 2B, according to one or more embodiments disclosed.

FIG. 5B illustrates a cross-sectional view of the stator can taken along line 5B-5B in FIG. 5A, according to one or more embodiments disclosed.

FIG. 6A illustrates a partial perspective view of an arcuate segment of another stator can that may be utilized in place of the stator can of FIGS. 2A and 2B, according to one or more embodiments disclosed.

FIG. 6B illustrates a cross-sectional view of the stator can taken along line 6B-6B in FIG. 6A, according to one or more embodiments disclosed.

FIG. 7A illustrates a partial perspective view of an arcuate segment of another stator can that may be utilized in place of the stator can of FIGS. 2A and 2B, according to one or more embodiments disclosed.

FIG. 7B illustrates a cross-sectional view of the stator can taken along line 7B-7B in FIG. 7A, according to one or more embodiments disclosed.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Further, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

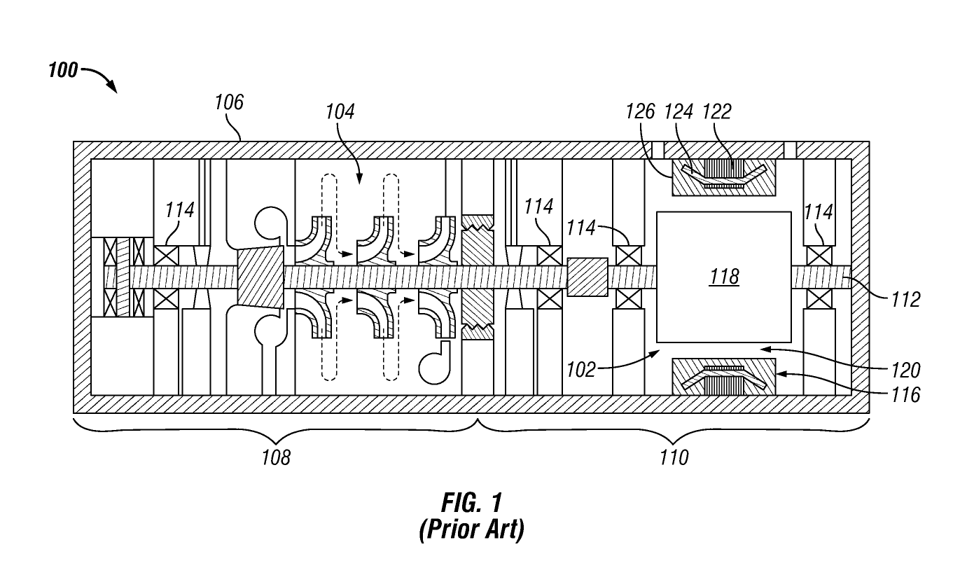

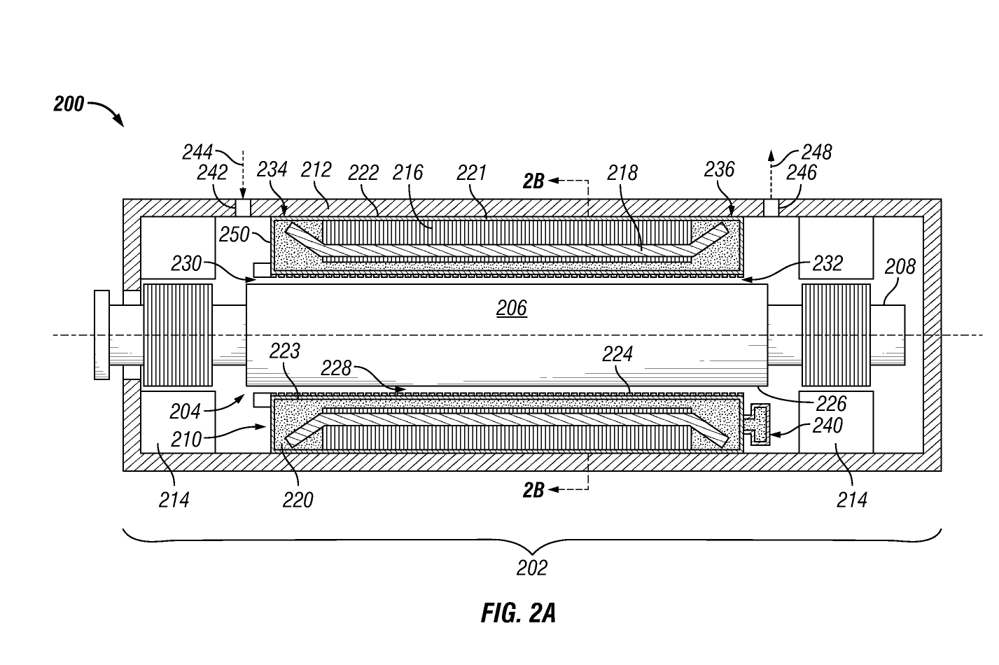

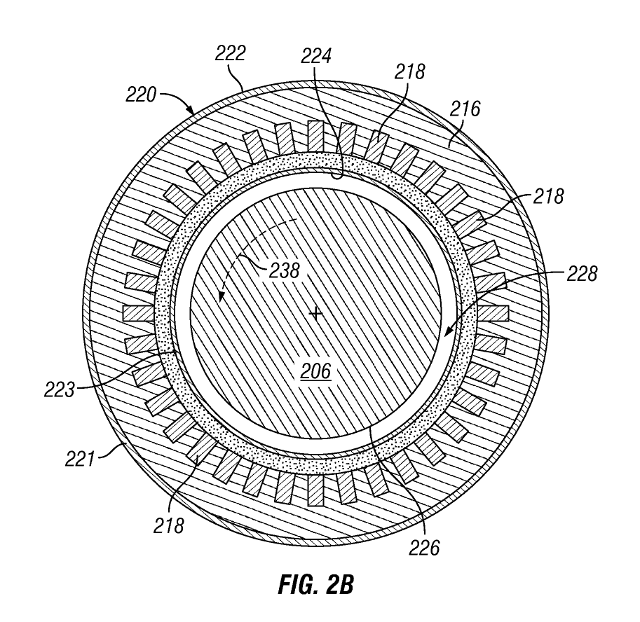

FIG. 2A illustrates a cross-sectional, schematic view of a motor section 202 of a motor-compressor 200 including an exemplary electric motor 204 that may be utilized in place of the electric motor 102 of FIG. 1, according to one or more embodiments. FIG. 2B illustrates a cross-sectional view of the electric motor 204 taken along line 2B-2B in FIG. 2A, according to one or more embodiments. In at least one embodiment, the electric motor 204 may include a rotor 206 coupled with a rotary shaft 208 and a stator 210 disposed about the rotor 206 and coupled with a housing 212 of the motor-compressor 200. As illustrated in FIG. 2A, the rotary shaft 208 and the rotor 206 coupled therewith may be supported by one or more bearings (two are shown 214) coupled with the housing 212. Illustrative bearings 214 may include, but are not limited to, magnetic bearings, such as active or passive magnetic bearings, or the like. As illustrated in FIGS. 2A and 2B, the stator 210 may include a stator core 216 and stator windings 218.

In at least one embodiment, the electric motor 204 may include a stator can 220 configured to protect one or more components of the stator 210 from a process fluid (e.g., cooling fluid) contained in and/or flowing through the motor section 202 of the motor-compressor 200. For example, the stator can 220 may be or include a hollow annular body 250 configured to enclose and protect the stator core 216 and the stator windings 218 from the process fluid contained in and/or flowing through the motor section 202. As illustrated in FIG. 2A, the hollow annular body 250 of the stator can 220 may include an outer wall 221 defining an outer radial surface 222 of the stator can 220, and an inner wall 223 defining an inner radial surface 224 of the stator can 220. As further illustrated in FIG. 2A, the stator can 220 may be coupled with the housing 212 along the outer radial surface 222 thereof. In at least one embodiment, the annular body 250 of the stator can 220 may be filled with a dielectric fluid and fitted with a pressure-balancing device 240 configured to equalize or regulate the pressure between an interior of the stator can 220 and an interior of the housing 212. The stator can 220 may be fabricated from one or more non-magnetic and/or chemically resistant materials including, but not limited to, stainless steel, INCONEL®, a metal alloy, a composite material, such as a graphite-epoxy composite material, or the like, or any combination thereof.

In at least one embodiment, illustrated in FIGS. 2A and 2B, the stator can 220 may be disposed radially outward of the rotor 206 such that the inner radial surface 224 of the stator can 220 and an outer radial surface 226 of the rotor 206 may at least partially define a radial clearance or gap 228 (e.g., magnetic air gap) therebetween. As illustrated in FIG. 2B, the radial gap 228 may allow the rotor 206 disposed radially inward of the stator can 220 to rotate within the stator can 220, as indicated by arrow 238. In at least one embodiment, illustrated in FIG. 2A, the radial gap 228 may have an inlet 230, disposed near or proximal a first axial end portion 234 of the stator can 220, and an outlet 232, disposed proximal a second axial end portion 236 of the stator can 220. As further described herein, a cooling fluid (e.g., the process fluid) may generally flow through the radial gap 228 from the inlet 230 to the outlet 232 to thereby cool one or more portions of the electric motor 204.

In an exemplary operation of the motor-compressor 200 with continued reference to FIG. 2A, the cooling fluid (e.g., the process fluid) may be introduced into the motor section 202 via an inlet 242 formed in the housing 212, as indicated by arrow 244. The cooling fluid may flow through the radial gap 228 from the inlet 230 to the outlet 232 thereof to thereby cool the electric motor 204. The cooling fluid from the outlet 232 of the radial gap 228 may then be discharged from the motor section 202 via an outlet 246 formed in the housing 212, as indicated by arrow 248.

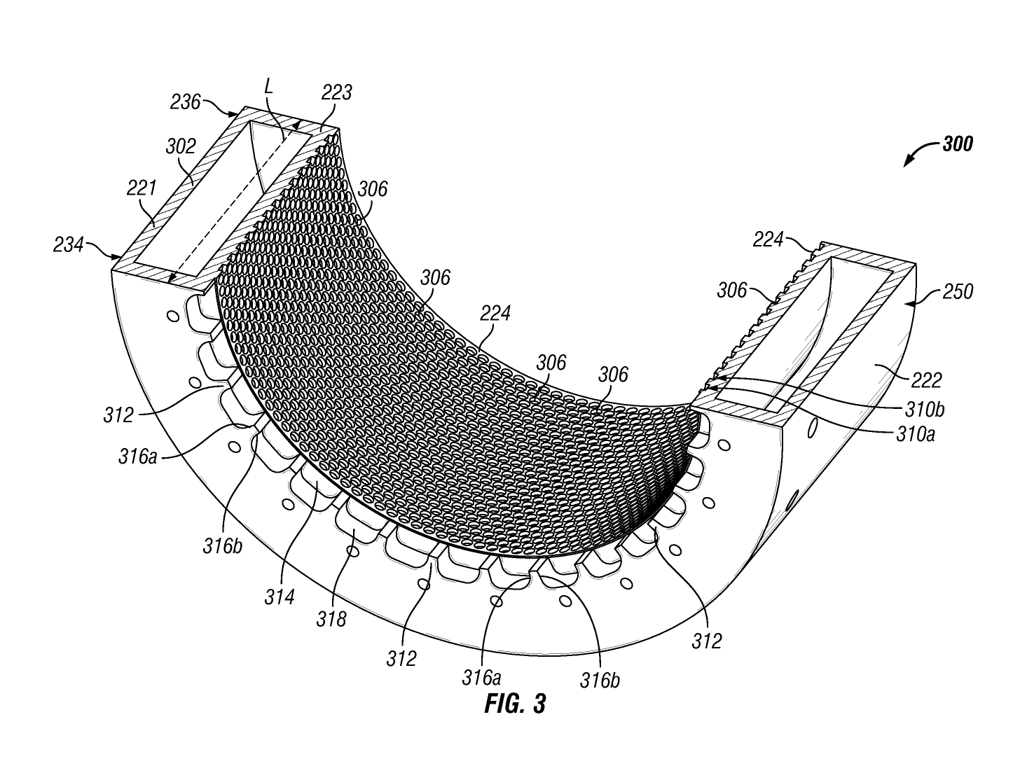

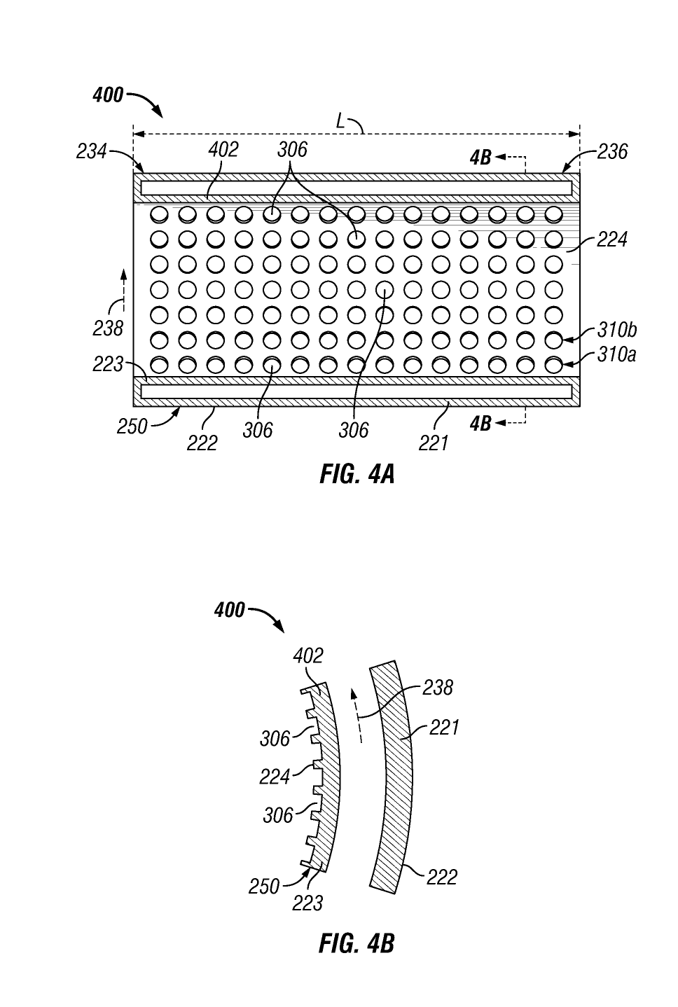

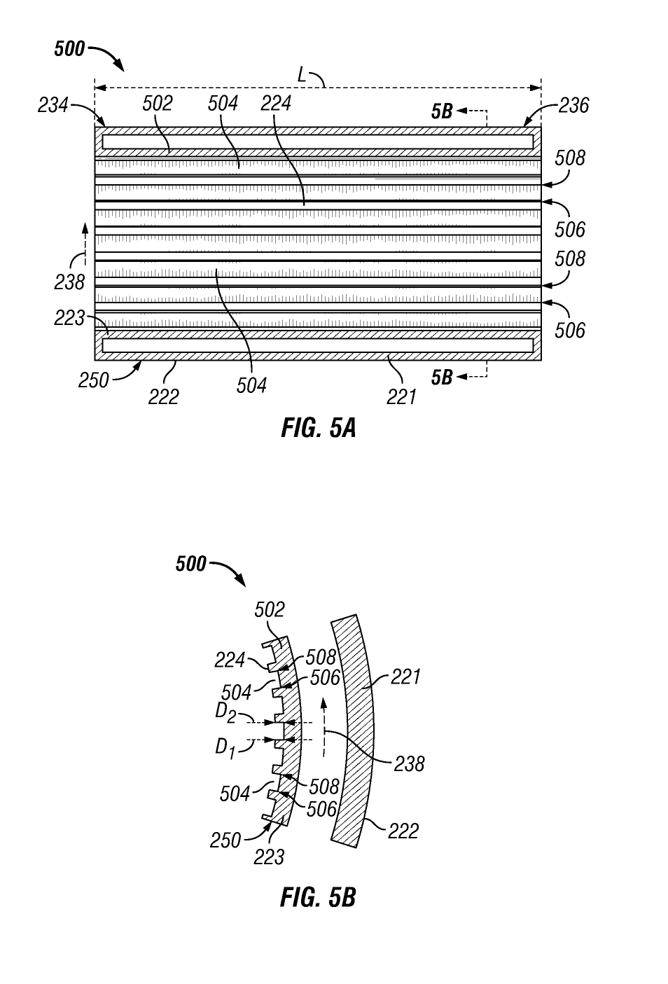

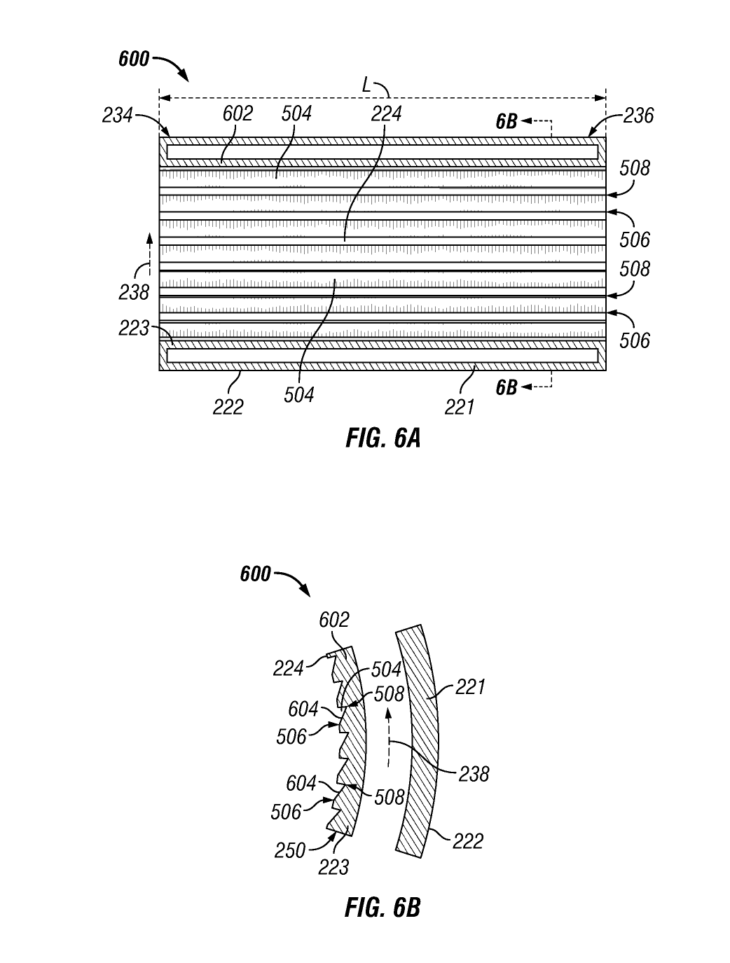

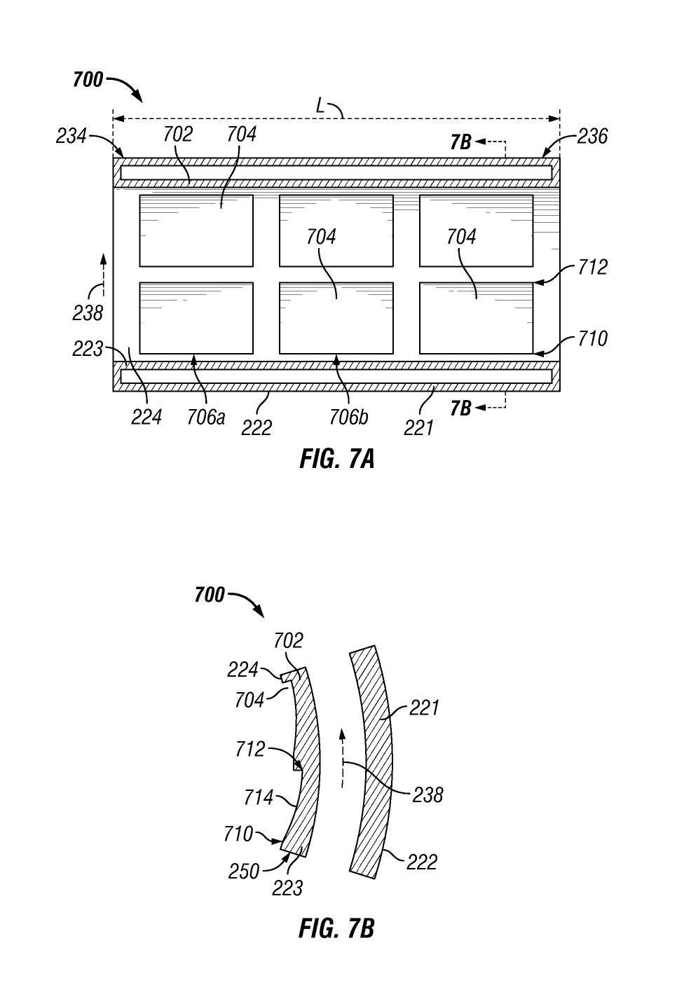

In at least one embodiment, illustrated in FIG. 2A, the annular body 250 of the stator can 220 may define various features and/or geometries along the inner radial surface 224 thereof to thereby provide the stator can 220 with a roughened inner radial surface. As further discussed herein, the annular body 250 may define a plurality of openings 306 (see FIGS. 3, 4A, and 4B), a plurality of grooves 504 (see FIGS. 5A, 5B, 6A, and 6B), and/or a plurality of recesses 704 (see FIGS. 7A and 7B) along the inner radial surface 224 of the respective stator cans 220, 300, 400, 500, 600, 700 to provide the roughened inner radial surface. In at least one embodiment, the various features and/or geometries forming the roughened inner radial surface may be configured to reduce or dampen destabilizing forces acting on the rotor 206 by reducing a swirling flow of the cooling fluid flowing through the radial gap 228. In another embodiment, the various features and/or geometries forming the roughened inner radial surface may also be configured to at least partially support or center the rotor 206 within the respective stator cans 220, 300, 400, 500, 600, 700.

FIG. 3 illustrates a perspective view of an arcuate segment 302 (e.g., lower arcuate segment) of another stator can 300 that may be utilized in place of the stator can 220 of FIGS. 2A and 2B, according to one or more embodiments. The stator can 300 illustrated in FIG. 3 may be similar in some respects to the stator can 220 described above and therefore may be best understood with reference to the description of FIGS. 2A and 2B, where like numerals may designate like components and will not be described again in detail.

As illustrated in FIG. 3, the stator can 300 may include a plurality of vanes or swirl breaks 312 disposed about the first axial end portion 234 of the annular body 250 and configured to minimize or reduce the swirling flow of the cooling fluid directed to the inlet 230 (see FIG. 2B) of the radial gap 228. For example, as previously discussed with reference to FIGS. 2A and 2B, the rotor 206 may rotate within the stator can 220. The rotation of the rotor 206 and the rotary shaft 208 coupled therewith may induce the swirling flow in at least a portion of the cooling fluid proximal the inlet 230 of the radial gap 228 and/or the first axial end portion 234 of the annular body 250. Accordingly, referring back to FIG. 3, the swirl breaks 312 disposed at the first axial end portion 234 of the stator can 300 may reduce the swirling flow of the cooling fluid flowing to the inlet 230 of the radial gap 228. In at least one embodiment, the swirl breaks 312 may be circumferentially spaced at substantially equal intervals or at varying intervals about the first axial end portion 234 of the annular body 250. As illustrated in FIG. 3, the swirl breaks 312 may extend axially from an axial end surface 314 of the annular body 250. The swirl breaks 312 may also extend radially inward from a radial end surface 318 of the first axial end portion 234 toward the inner radial surface 224 of the stator can 300. In at least one embodiment, at least a portion of the swirl breaks 312 may be arcuate or curved. For example, as illustrated in FIG. 3, respective sidewalls 316a, 316b of the swirl breaks 312 may be curved along one or more portions thereof. In another embodiment, the respective sidewalls 316a, 316b of the swirl breaks 312 may be planar or straight along one or more portions thereof. The annular body 250 may be machined via one or more processes to form the swirl breaks 312 about the first axial end portion 234 of the stator can 300.

In at least one embodiment, the stator can 300 may define one or more features along the inner radial surface 224 to thereby provide the stator can 300 with a roughened inner radial surface. For example, the stator can 300 may define a plurality of openings 306 disposed along the inner radial surface 224 thereof to provide the roughened inner radial surface. As illustrated in FIG. 3, the plurality of openings 306 may at least partially extend from the inner radial surface 224 toward the outer radial surface 222 of the stator can 300. In at least one embodiment, each of the openings 306 may have a uniform or constant depth. For example, the depth of one of the openings 306 may be equal or substantially equal to the depth the remaining openings 306. In another embodiment, the depth of the openings 306 may vary from one another. For example, the depth of the openings 306 may vary (e.g., increase and/or decrease) between the first axial end portion 234 and the second axial end portion 236 of the stator can 300. In at least one embodiment, the annular body 250 may define the openings 306 substantially along an axial length (L) of the stator can 300. For example, as illustrated in FIG. 3, the openings 306 may be disposed substantially along the entire axial length (L) between the first axial end portion 234 and the second axial end portion 236 of the stator can 300. In another embodiment, the openings 306 may be disposed along a portion of the axial length (L) of the stator can 300.

In at least one embodiment, the openings 306 may be randomly disposed along the inner radial surface 224 of the stator can 300. In another embodiment, the openings 306 may be arranged in an ordered pattern along the inner radial surface 224 of the stator can 300. For example, as illustrated in FIG. 3, the openings 306 may be arranged in one or more rows 310a, 310b extending circumferentially about the inner radial surface 224 of the stator can 300. The openings 306 may be disposed circumferential about the inner radial surface 224 of the stator can 300 at equal intervals or at varying intervals. In at least one embodiment, illustrated in FIG. 3, the openings 306 in one row 310a may be staggered or circumferentially offset from the openings 306 of an adjacent row 310b.

FIG. 4A illustrates a partial perspective view of an arcuate segment 402 of another stator can 400 that may be utilized in place of the stator can 220 of FIGS. 2A and 2B, according to one or more embodiments. FIG. 4B illustrates a cross-sectional view of the stator can 400 taken along line 4B-4B in FIG. 4A, according to one or more embodiments. The stator can 400 illustrated in FIGS. 4A and 4B may be similar in some respects to the stator cans 220, 300 described above and therefore may be best understood with reference to the description of FIGS. 2A, 2B, and 3, where like numerals may designate like components and will not be described again in detail. As illustrated in FIG. 4A, in at least one embodiment, the openings 306 in one row 310a may be aligned with the openings 306 of the adjacent row 310b.

As previously discussed, the stator cans 300, 400 described herein may be utilized in place of the stator can 220 of FIG. 2A. In at least one embodiment, the respective openings 306 disposed along the respective inner radial surfaces 224 of the stator cans 300, 400 may be configured to reduce vibrations and increase rotordynamic stability of the rotor 206. For example, referring briefly to FIG. 2A, at least a portion of the cooling fluid flowing through the radial gap 228 may flow and/or expand into the respective openings 306 disposed along the respective inner radial surfaces 224 of the stator cans 300, 400. In at least one embodiment, the flow and/or expansion of the cooling fluid into the respective openings 306 of the stator cans 300, 400 may reduce the vibrations of the rotor 206 and the rotary shaft 208 coupled therewith, thereby increasing the rotordynamic stability of the electric motor 204. For example, the flow and/or expansion of the cooling fluid into the respective openings 306 of the stator cans 300, 400 may dissipate at least a portion of the kinetic energy in the cooling fluid flowing through the radial gap 228, thereby reducing the vibrations and increasing the rotordynamic stability of the rotor 206. In another example, the flow and/or expansion of the cooling fluid may at least partially reduce the propagation of circumferential flow perturbations within the cooling fluid flowing through the radial gap 228, which may reduce cross-coupling forces on the rotor 206 that produce unstable whirl. In another example, the flow and/or expansion of the cooling fluid into the respective openings 306 of the stator cans 300, 400 may generate damping forces that may overcome cross-coupling stiffness and/or destabilizing forces acting upon the rotor 206.

While FIGS. 3, 4A, and 4B illustrate the openings 306 as having a circular shape, the shape of the openings 306 are merely exemplary. Accordingly, it may be appreciated that the shape and/or dimensions of the openings 306 may vary without departing from the scope of the disclosure. For example, the openings 306 may have an elliptical shape, a polygonal shape (e.g., a honeycomb shape), or the like, without departing from the scope of the disclosure. It may further be appreciated that, in addition to or in substitution of the openings 306, the annular body 250 may define other features and/or geometries along the inner radial surface 224 of the stator can. For example, as further described herein, the annular body 250 may define a plurality of grooves (see FIGS. 5A, 5B, 6A, and 6B), a plurality of pockets or recesses (see FIGS. 7A and 7B), or the like, along the inner radial surface 224 of the stator can.

FIG. 5A illustrates a partial perspective view of an arcuate segment 502 of another stator can 500 that may be utilized in place of the stator can 220 of FIGS. 2A and 2B, according to one or more embodiments. FIG. 5B illustrates a cross-sectional view of the stator can 500 taken along line 5B-5B in FIG. 5A, according to one or more embodiments. The stator can 500 illustrated in FIGS. 5A and 5B may be similar in some respects to the stator can 220 described above and therefore may be best understood with reference to the description of FIGS. 2A and 2B, where like numerals designate like components and will not be described again in detail.

As illustrated in FIG. 5A, the annular body 250 may define a plurality of grooves 504 along the inner radial surface 224 of the stator can 500 to thereby provide the stator can 500 with the roughened inner radial surface. In at least one embodiment, the grooves 504 may span or extend axially along a portion of the axial length (L) of the stator can 500. In another embodiment, the grooves 504 may extend along the entire axial length (L) of the stator can 500. For example, as illustrated in FIG. 5A, the grooves 504 may extend substantially between the first axial end portion 234 and the second axial end portion 236 of the stator can 500. Additionally, as illustrated in FIG. 5B, the grooves 504 may be circumferentially offset from one another along the inner radial surface 224 of the stator can 500. In at least one embodiment, illustrated in FIG. 5A, the grooves 504 may be linear and disposed parallel with one another. In another embodiment, the grooves 504 may be slanted or angled with respect to a longitudinal axis of the stator can 500. It may be appreciated that the grooves 504 may be divergent and/or angled at varying angles with respect to the longitudinal axis of the stator can 500. In yet another embodiment, at least a portion of the grooves 504 may be curved between the first axial end portion 234 and the second axial end portion 236 of the stator can 500.

As illustrated in FIG. 5B, the grooves 504 may at least partially extend from the inner radial surface 224 toward the outer radial surface 222 of the annular body 250. In at least one embodiment, each of the grooves 504 may have a constant radial length or depth between a first circumferential end portion 506 and a second circumferential end portion 508 thereof. For example, as illustrated in FIG. 5B, a depth (D1) of the first circumferential end portion 506 may be equal or substantially equal to a depth (D2) of the second circumferential end portion 508. In another embodiment, as further described herein with reference to FIGS. 6A and 6B, each of the grooves 504 may not have a uniform or constant depth between the first circumferential end portion 506 and the second circumferential end portion 508 thereof.

FIG. 6A illustrates a partial perspective view of an arcuate segment 602 of another stator can 600 that may be utilized in place of the stator can 220 of FIGS. 2A and 2B, according to one or more embodiments. FIG. 6B illustrates a cross-sectional view of the stator can 600 taken along line 6B-6B in FIG. 6A, according to one or more embodiments. The stator can 600 illustrated in FIGS. 6A and 6B may be similar in some respects to the stator cans 220, 500 described above and therefore may be best understood with reference to the description of FIGS. 2A, 2B, 5A, and 5B, where like numerals designate like components and will not be described again in detail.

As previously discussed, with reference to FIG. 5B, each groove 504 may not have a uniform or constant depth between the first circumferential end portion 506 and the second circumferential end portion 508 thereof. For example, the depth of the grooves 504 may vary (e.g., increase or decrease) between the first circumferential end portion 506 and the second circumferential end portion 508 thereof. As illustrated in FIG. 5B, the depth of the grooves 504 may increase from the first circumferential end portion 506 to the second circumferential end portion 508 thereof to thereby form a plurality of sawtooth grooves. In at least one embodiment, an inner end surface 604 of each of the grooves 504 may be linear between the first circumferential end portion 506 and the second circumferential end portion 508. In another embodiment, at least a portion of the inner end surface 604 of each of the grooves 504 may be curved or arcuate between the first circumferential end portion 506 and the second circumferential end portion 508. In an exemplary embodiment, the depth of the grooves 504 may generally increase in a direction corresponding to the rotation of the rotor 206 (see FIGS. 2A and 2B). For example, as illustrated in FIG. 6B, the depth of the grooves 504 may generally increase in the direction in which the rotor 206 may rotate, as indicated by arrow 238.

In at least one embodiment, the respective grooves 504 extending along the respective inner radial surfaces 224 of the stator cans 500, 600 may be configured to reduce vibrations and increase rotordynamic stability of the rotor 206 (see FIGS. 2A and 2B). For example, referring briefly to FIG. 2A with continued reference to FIGS. 5B and 6B, at least a portion of the cooling fluid flowing through the radial gap 228 may flow and/or expand into the respective grooves 504 extending along the respective inner radial surfaces 224 of the stator cans 500, 600. The flow and/or expansion of the cooling fluid into the respective grooves 504 of the stator cans 500, 600 may reduce the circumferential swirl of the cooling fluid that results in cross-coupling forces between stationary and rotating surfaces that promote rotor instability, and may generate damping forces that may overcome cross-coupling stiffness and/or destabilizing forces acting upon the rotor 206. In at least one embodiment, the respective grooves 504 extending along the respective inner radial surfaces 224 of the stator cans 500, 600 may also be configured to promote or facilitate the flow of the cooling fluid through the radial gap 228. For example, as previously discussed, the respective grooves 504 may extend substantially between the first axial end portion 234 and the second axial end portion 236 of the stator cans 500, 600. Accordingly, the respective grooves 504 of the stator cans 500, 600 may provide a flowpath between the inlet 230 (e.g., proximal the first axial end portion 234) and the outlet 232 (e.g., proximal the second axial end portion 236) of the radial gap 228 to facilitate the flow of the cooling fluid through the radial gap 228.

FIG. 7A illustrates a partial perspective view of an arcuate segment 702 of another stator can 700 that may be utilized in place of the stator can 220 of FIGS. 2A and 2B, according to one or more embodiments. FIG. 7B illustrates a cross-sectional view of the stator can 700 taken along line 7B-7B in FIG. 7A, according to one or more embodiments. The stator can 700 illustrated in FIGS. 7A and 7B may be similar in some respects to the stator can 220 described above and therefore may be best understood with reference to the description of FIGS. 2A and 2B, where like numerals designate like components and will not be described again in detail.

As previously discussed, the annular body 250 may define a plurality of pockets or recesses 704 along the inner radial surface 224 of the stator can 700. For example, as illustrated in FIG. 7A, the annular body 250 may define the recesses 704 substantially along the axial length (L) thereof. In at least one embodiment, the recesses 704 may be randomly disposed along the inner radial surface 224 of the stator can 700. In another embodiment, the recesses 704 may be arranged in an ordered pattern along the inner radial surface 224 of the stator can 700. For example, as illustrated in FIG. 7A, the recesses 704 may be arranged in one or more rows 706a, 706b extending circumferentially about the inner radial surface 224 of the stator can 700. The recesses 704 may be disposed circumferentially about the inner radial surface 224 of the stator can 700 at equal intervals or at varying intervals. In at least one embodiment, the recesses 704 in one row 706a may be staggered or circumferentially offset from the recesses 704 in an adjacent row 706b. In another embodiment, illustrated in FIG. 7A, the recesses 704 in one of the rows 706a may be aligned with the recesses 704 in the adjacent row 706B. In an exemplary embodiment, illustrated in FIG. 7A, each of the recesses 704 may have a rectangular shape. While FIG. 7A illustrates the recesses 704 as having a rectangular shape, the shape of the recesses 704 are merely exemplary. According, it may be appreciated that the shape and/or dimensions of the recesses 704 may vary without departing from the scope of the disclosure. For example, the recesses 704 may have a polygonal shape (e.g., a square shape), or the like, without departing from the scope of the disclosure.

As illustrated in FIG. 7B, the recesses 704 may at least partially extend from the inner radial surface 224 of the annular body 250 toward the outer radial surface 222 of the annular body 250. In at least one embodiment, each of the recesses 704 may have a uniform or constant depth between a first circumferential end portion 710 and a second circumferential end portion 712 thereof. In another embodiment, each of the recesses 704 may not have a uniform or constant depth between the first circumferential end portion 710 and the second circumferential end portion 712 thereof. For example, referring to FIG. 7B, the depth of the recesses 704 may vary (e.g., increase or decrease) between the first circumferential end portion 710 and the second circumferential end portion 712 thereof. In an exemplary embodiment, illustrated in FIG. 7B, the depth of the recesses 704 may increase from the first circumferential end portion 710 toward the second circumferential end portion 712 thereof. In at least one embodiment, an inner end surface 714 of each of the recesses 704 may be linear between the first circumferential end portion 710 and the second circumferential end portion 712. In another embodiment, at least a portion of the inner end surface 714 of each of the recesses 704 may be curved or arcuate between the first circumferential end portion 710 and the second circumferential end portion 712. In an exemplary embodiment, the depth of the recesses 704 may generally increase in the direction in which the rotor 206 (see FIGS. 2A and 2B) may rotate, as indicated by arrow 238.

In at least one embodiment, the recesses 704 disposed along the inner radial surface 224 of the stator can 700 may be configured to support the rotor 206 (see FIGS. 2A and 2B) by forming or generating stationary areas of high pressure. For example, referring briefly to FIG. 2B, the rotation of the rotor 206 may induce a swirling flow in at least a portion of the cooling fluid (e.g., the process fluid) flowing through the radial gap 228. The swirling flow of the cooling fluid may follow the rotation of the rotor 206, indicated by arrow 238. Referring back to FIG. 7B, the swirling flow of the cooling fluid may strike the second circumferential end portions 712 of the recesses 704 to thereby generate pressure heads or pressure points at or proximal the second circumferential end portions 712. Referring back to FIG. 2B, the pressure heads generated at or proximal the respective second circumferential end portions 712 may exert forces (e.g., pressure forces) about the rotor 206 to at least partially support and/or center the rotor 206 within the stator can 700.

As discussed herein, the annular body 250 may define various features and/or geometries along the respective inner radial surfaces 224 of the stator cans 220, 300, 400, 500, 600, 700. For example, the annular body 250 may define the plurality of openings 306 (see FIGS. 3, 4A, and 4B), the plurality of grooves 504 (see FIGS. 5A, 5B, 6A, and 6B), or the plurality of recesses 704 (see FIGS. 7A and 7B) along the respective inner radial surfaces 224 of the stator cans 220, 300, 400, 500, 600, 700. In at least one embodiment, the various features and/or geometries defined along the inner radial surface 224 of the stator cans 220, 300, 400, 500, 600, 700 may be formed or machined via one or more processes. In an exemplary embodiment, stator cans of pre-existing electric motors or electric motors in service may be machined via one or more processes to form the various features and/or geometries described herein to improve the rotordynamic stability of the electric motors.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A stator can for an electric motor, comprising:
an annular body configured to be disposed radially outward of a rotor of the electric motor such that an inner radial surface of the annular body and an outer radial surface of the rotor at least partially define a radial gap therebetween, a first axial end portion of the annular body at least partially defining an inlet of the radial gap; and
a plurality of swirl breaks disposed about the first axial end portion of the annular body and configured to reduce a swirling flow of a cooling fluid flowing to the inlet of the radial gap, wherein the plurality of swirl breaks extends from an axial end surface of the annular body, and further extends radially inward from a radial end surface of the annular body toward the inner radial surface of the annular body.

2. (canceled)

3. (canceled)

4. The stator can of claim 1, wherein sidewalls of each swirl break of the plurality of swirl breaks are curved.

5. The stator can of claim 1, wherein sidewalls of each swirl break of the plurality of swirl breaks are planar.

6. The stator can of claim 1, wherein the annular body defines a plurality of openings along the inner radial surface thereof, the plurality of openings at least partially extending from the inner radial surface toward an outer radial surface of the annular body.

7. The stator can of claim 1, wherein the annular body defines a plurality of grooves along the inner radial surface thereof, the plurality of grooves at least partially extending from the inner radial surface toward an outer radial surface of the annular body.

8. The stator can of claim 7, wherein the plurality of grooves extend axially along at least a portion of the annular body.

9. The stator can of claim 7, wherein each groove of the plurality of grooves has a constant depth between a first circumferential end portion and a second circumferential end portion thereof.

10. The stator can of claim 7, wherein a depth of each groove of the plurality of grooves increases between a first circumferential end portion and a second circumferential end portion thereof.

11. The stator can of claim 1, wherein the annular body defines a plurality of rectangular recesses along the inner radial surface thereof, the plurality of rectangular recesses at least partially extending from the inner radial surface toward an outer radial surface of the annular body.

12. The stator can of claim 11, wherein a depth of each rectangular recess of the plurality of rectangular recesses increases from a first circumferential end portion to a second circumferential end portion thereof.

13. The stator can of claim 12, wherein an inner end surface of each rectangular recess of the plurality of rectangular recesses is arcuate.

14. A stator can for an electric motor, comprising:
a hollow, annular body disposed radially outward of a rotor of the electric motor such that an inner radial surface of the annular body and an outer radial surface of the rotor at least partially define a radial gap therebetween, the hollow, annular body defining a plurality of geometries along the inner radial surface thereof; and
a plurality of swirl breaks disposed about a first axial end portion of the annular body and configured to reduce a swirling flow of a cooling fluid flowing to an inlet of the radial gap, wherein the plurality of swirl breaks extends from an axial end surface of the annular body, and further extends radially inward from a radial end surface of the annular body toward the inner radial surface of the annular body.

15. The stator can of claim 14, wherein the plurality of geometries defined along the inner radial surface of the annular body include at least one of a plurality of openings, a plurality of grooves, a plurality of sawtooth grooves, and a plurality of recesses.

16. An electric motor for a motor-compressor, comprising:
a rotor;
a stator dispose radially outward of the rotor; and
a stator can enclosing the stator and configured to protect the stator from a process fluid flowing through the motor-compressor and increase rotordynamic stability of the rotor, the stator can comprising:
an annular body disposed radially outward of the rotor such that an inner radial surface of the annular body and an outer radial surface of the rotor at least partially define a radial gap therebetween, a first axial end portion of the annular body at least partially defining an inlet of the radial gap; and
a plurality of vanes disposed about the first axial end portion of the annular body and configured to reduce a swirling flow of the process fluid flowing to the inlet of the radial gap and thereby increase the rotordynamic stability of the rotor, wherein the plurality of vanes extends from an axial end surface of the annular body, and further extends radially inward from a radial end surface of the annular body toward the inner radial surface of the annular body.

17. The electric motor of claim 16, wherein the annular body defines a plurality of openings along the inner radial surface thereof, the plurality of openings at least partially extending from the inner radial surface toward an outer radial surface of the annular body and configured to increase the rotordynamic stability of the rotor.

18. The electric motor of claim 16, wherein the annular body defines a plurality of axial grooves along the inner radial surface thereof, the plurality of axial grooves configured to increase the rotordynamic stability of the rotor.

19. The electric motor of claim 16, wherein the annular body defines a plurality of sawtooth grooves extending axially along the inner radial surface thereof, the plurality of sawtooth grooves configured to increase the rotordynamic stability of the rotor.

20. The electric motor of claim 16, wherein the annular body defines a plurality of recesses at least partially extending from the inner radial surface toward an outer radial surface thereof, the plurality of recesses configured to at least partially support the rotor within the stator can.
